(19) United States
(12) Patent Application Publication
(10) Pub. No.: US 2005/0098536 A1
(43) Pub. Date: May 12, 2005

(54) Method of etching oxide with high selectivity

(75) Inventors: Jinhan Choi, Santa Clara, CA (US); Jae Gyoo Lee, Sungnam City (KR)

Correspondence Address: MOSER, PATTERSON & SHERIDAN, LLP;APPLIED MATERIALS INC, 595 SHREWSBURY AVE, SUITE 100, SHREWSBURY, NJ, 07702, US

(73) Assignee: Applied Materials, Inc.

(21) Appl. No.: 10/706,904

(22) Filed: Nov. 12, 2003

(51) Int. Cl. C23F 1/00; B44C 1/22; C03C 15/00; C03C 25/68

(52) U.S. Cl. 216/67

(57) ABSTRACT

A method of etching oxide in a high-density plasma using a fluorinated hydrocarbon gas and a fluorocarbon gas chemistry to provide a selectivity of oxide to photoresist in excess of 300:1.

### BACKGROUND OF THE INVENTION

1. Field of the Invention

The present invention generally relates to a method for fabricating devices on semiconductor substrates. More specifically, the present invention relates to a method for etching an oxide layer with high selectivity to photoresist.

2. Description of the Related Art

Ultra-large-scale integrated (ULSI) circuits typically include more than one million transistors that are formed on a semiconductor substrate and cooperate to perform various functions within an electronic device. During the formation of the devices, oxide materials such as silicon dioxide (SiO₂) and alumina (Al₂O₃) are etched to form self-aligned contacts, on-cylinder storage, bit line contacts, high aspect ratio contacts and the like. To etch the oxide material in well defined locations, a photoresist material is patterned to form openings where the oxide will be removed. To facilitate relatively rapid etching, reactive ion etching (RIE) is used wherein a plasma enhances the etch process. An RIE technique uses a chlorine-based chemistry to etch silicon dioxide.

Generally, the selectivity of oxide over photoresist for the chlorine-based etchant gases that are used in an RIE process is low (e.g., about 2:1). As such, thick layers of photoresist must be used. Additionally, a low density plasma is used to provide additional selectivity of oxide over the photoresist. However, a low density plasma has a slow etch rate. As such, throughput of substrates is relatively low.

Therefore, here is a need in the art for a method of etching oxide materials with high selectivity to photoresist.

### SUMMARY OF THE INVENTION

The present method is a method of etching an oxide material with high selectivity to photoresist. The method can be performed using a high density plasma. The method comprises providing to a plasma etch reactor a substrate having a patterned photoresist layer formed over an oxide layer, supplying a fluorocarbon gas and a fluorinated hydrocarbon gas to the reactor, igniting a plasma and etching the oxide material. The selectivity of oxide to photoresist exceeds 300:1.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 depicts a flow diagram of a method of etching an oxide in accordance with the present invention;

FIGS. 2A-2D together depict a sequence of schematic, cross-sectional views of a substrate having an opening being etched into an oxide layer in accordance with the method of FIG. 1; and

FIG. 3 depicts a schematic diagram of an exemplary plasma processing apparatus of the kind used in performing the method of FIG. 1.

To facilitate understanding, identical reference numerals have been used, where possible, to designate identical elements that are common to the figures.

It is to be noted, however, that the appended drawings illustrate only typical embodiments of this invention, and are therefore not to be considered limiting of its scope, for the invention may admit to other equally effective embodiments.

### DETAILED DESCRIPTION

The present invention is a method of etching an oxide material with high selectivity to photoresist material. The method comprises providing a substrate having a patterned photoresist layer formed over an oxide layer, and plasma etching the oxide using a gas mixture containing fluorinated hydrocarbon gas and a fluorocarbon gas. The invention achieves selectivity of oxide to photoresist greater than 300:1.

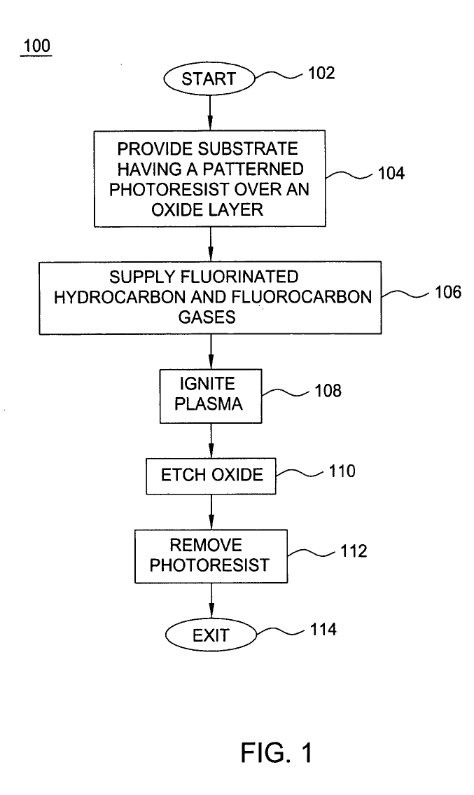

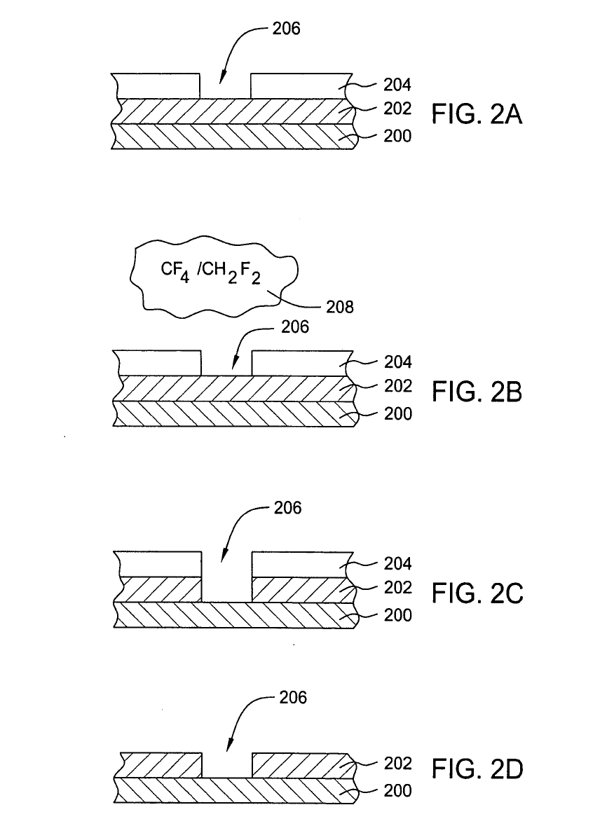

FIG. 1 depicts a flow diagram of a method 100 of etching an oxide layer in accordance with the present invention. FIGS. 2A-2D together depict a sequence of schematic, cross-sectional views of a substrate having an oxide layer being etched in accordance with the method 100 of FIG. 1. The cross-sectional views in FIGS. 2A-2D relate to individual process steps that are used to etch the oxide layer. Sub-processes such as lithographic processes (e.g., exposure and development of photoresist, and the like), and wafer cleaning procedures among others are well known in the art and, as such, are not shown in FIG. 1 and FIGS. 2A-2D. The illustrations in FIGS. 2A-2D are not depicted to scale and are simplified for illustrative purposes.

The method 100 starts at step 102 and proceeds to step 104. At step 104, a substrate having a patterned photoresist material formed over an oxide layer is provided. The oxide may be silicon dioxide, alumina, a doped glass material, and the like. Other oxide materials may also benefit from the etching recipe used in this invention. At step 106, fluorinated hydrocarbon gas and fluorocarbon gas are supplied to the etch reactor. In one embodiment of the invention, the fluorinated hydrocarbon gas is CH₂F₂ and the fluorocarbon gas is CF₄. Other fluorinated hydrocarbon gases include CHF₃ and CH₃F. Other fluorocarbon gases include C₄F₆ and C₄F₈; however, these gases can result in excessive and undesirable carbon deposition. As such, using a combination of CF₄ and CH₂F₂ provides good particle and stable processing, i.e., very little process shift). At step 108, the gases within the chamber are ignited into a plasma by coupling RF energy to the gases. At step 110, the oxide is etched by the fluorine. At step 112, the photoresist is removed leaving the oxide with a gap 206 that was defined by the photoresist. The process ends at step 114.

FIG. 2A depicts a substrate 200 supporting an oxide layer 202 and a pattern photoresist layer 204 that defines a gap 206 such as a via or trench. The photoresist layer 204 may comprise a sub-layer (not shown) of an anti-reflective coating (ARC) or a bottom anti-reflective coating (BARC) that is used to control a reflection of light during an exposure of the photoresist layer. The ARC or BARC sub-layer may be composed, for example, from inorganic materials such as silicon nitride (Si₃N₄), silicon carbide (SiC), and the like. Alternatively, the ARC or BARC sub-layer may be composed from organic materials such as polyamides and polysulfones. As a feature size is reduced, inaccuracies in a pattern transfer process can arise from optical limitations inherent to the lithographic process, such as the light reflection. When applied, the ARC sub-layer is formed upon the photoresist layer 204, and the BARC sub-layer is formed upon the oxide layer 202. The photoresist layer 204 is applied using a conventional procedure and generally has a total thickness of up to 11,000 Angstroms.

In FIG. 2B the fluorinated hydrocarbon and fluorocarbon gases are supplied in a gas mixture 208 that generally includes helium and oxygen. In one specific embodiment, the gas mixture 208 comprises CF₄, CH₂F₂, and HeO₂. The addition of an oxygen-containing gas is optional. The addition of oxygen into the chemistry will reduce the selectivity with respect to the photo resist material; however, the oxygen controls the carbon polymer deposition on the walls and lid of the chamber. If an oxygen-containing gas is not used, the carbon polymer residue can be removed during an in-situ cleaning cycle after the substrate has been removed from the chamber. FIG. 2C depicts the oxide layer 202 being etched within the gap 206 by the fluorine within the fluorinated hydrocarbon and the fluorocarbon gases. FIG. 2D depicts the oxide layer after etching and after the photoresist has been removed using a conventional photoresist ashing process.

The etch process of step 110 can be accomplished in a Decoupled Plasma Source (DPS®) II module of the Centura® system available from Applied Materials, Inc. In the DPS® II reactor, the ion density and ion energy may be controlled independently using a plasma power source and biasing power source, respectively. The plasma power source generates and sustains a high density plasma, while the biasing power source electrically biases the wafer. The DPS® II module provides a wide process window over changes in plasma and biasing powers, etch gas chemistry and pressure, wafer temperature, and the like. The process time can be terminated, for example, by using an endpoint detection system to detect a particular optical emission, upon a particular duration occurring, or upon some other indicator suitable for determining the end of the etch process.

In one embodiment, during etching of the silicon dioxide layer 202 in the DPS® II module at step 110, a gas mixture is provided that includes CF₄ at a rate of 10 to 200 sccm, as well as CH₂F₂ at a rate of 10 to 200 sccm (i.e., flow ratio between the etchant gases ranges from 1:1 to 1:20) and HeO₂ at a rate of 0 to 100 sccm. 200 to 3000 W of power is coupled to a plasma formed from the gas mixture and the wafer is biased with 0 to 500 W of bias power. The wafer is maintained at a temperature of about 10 to 100 degrees Celsius, and the reaction chamber is maintained at 2 to 100 mTorr. One specific process recipe provides CF₄ at a rate of 80 sccm, CH₂F₂ at a rate of 120 sccm, (CF₄:CH₂F₂ flow ratio of 1:1.5), HeO₂ at a rate of 30 sccm, 700 W of plasma source power and 500 W of biasing power, a wafer temperature of 50 degrees Celsius, and a chamber pressure of 6 mTorr.

In one application of the invention, the photoresist mask is generally about 10,700 Angstroms thick and the oxide layer is about 2,880 Angstroms thick. Using the chemistry disclosed previously, the photoresist etch rate is zero Angstroms per minute while the oxide etch rate is 1,980 Angstroms per minute, providing oxide to photoresist selectivity of infinity. When etching blanket wafers that are either uniformly covered with oxide or uniformly covered with photoresist and etching them with the specific chemistry discussed above, the oxide etch rate is about 2,024 Angstroms per minute and the photoresist etch rate is about 6 Angstroms per minute providing an oxide to photoresist selectivity of about 337:1. Such a high selectivity permits the recipe to be used in a high density plasma reactor (i.e., reactors having a plasma density greater than about 10¹¹ cm³. An empirical study has shown that adjustments in the amount, or the ratio of CF₄:CH₂F₂ provides substantial control of the selectivity. Adjusting these ratios substantially changes the photoresist etch rate with only a moderate change in the SiO₂ etch rate. Thus, the chemistry disclosed herein provides a manner in which the selectivity can be controlled.

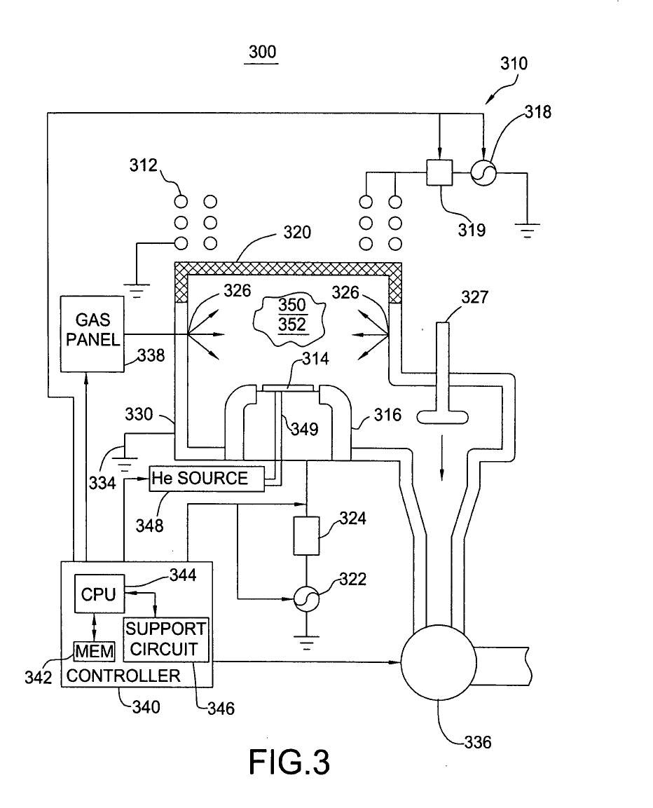

FIG. 3 depicts a schematic diagram of a DPS® II etch reactor 300 that may be uses to practice the method 100 of FIG. 1. The reactor 300 comprises a process chamber 310 having a wafer support pedestal 316 within a conductive body (wall) 330, and a controller 340.

The support pedestal (cathode) 316 is coupled, through a first matching network 324, to a bias power source 322. The bias source 322 generally is capable of producing up to 500 W at a frequency of approximately 13.56 MHz. In other embodiments, the source 322 may be a DC or pulsed DC source. The wall 330 has a substantially flat dielectric ceiling 320. Other modifications of the chamber 310 may have other types of ceilings, e.g., a dome-shaped ceiling. Typically, the wall 330 is coupled to an electrical ground 334. Above the ceiling 320 is disposed at least one inductive coil antenna 312 (two antennas are shown). The antenna 312 is coupled, through a second matching network 319, to a plasma power source 318. The plasma source 318 typically is capable of producing up to 3000 W at a tunable frequency in a range from 50 kHz to 13.56 MHz. Generally, 13.56 MHz is used during an etch process.

A controller 340 comprises a central processing unit (CPU) 344, a memory 342, and support circuits 346 for the CPU 344 and facilitates control of the components of the DPS etch process chamber 310 and, as such, of the etch process, as discussed below in further detail.

In operation, a semiconductor wafer 314 is placed on the pedestal 316 and process gases are supplied from a gas panel 338 through entry ports 326 and form a gaseous mixture 350. The gaseous mixture 350 is ignited into a plasma 355 in the chamber 310 by applying power from the plasma and bias sources 318 and 322 to the antenna 312 and the cathode 316, respectively. The pressure within the interior of the chamber 310 is controlled using a throttle valve 327 and a vacuum pump 336. The temperature of the chamber wall 330 is controlled using liquid-containing conduits (not shown) that run through the wall 330.

The temperature of the wafer 314 is controlled by stabilizing a temperature of the support pedestal 316. In one embodiment, the helium gas from a gas source 348 is provided via a gas conduit 349 to channels formed by the back of the wafer 314 and grooves (not shown) in the pedestal surface. The helium gas is used to facilitate heat transfer between the pedestal 316 and the wafer 314. During the processing, the pedestal 316 may be heated by a resistive heater (not shown) within the pedestal to a steady state temperature and then the helium gas facilitates uniform heating of the wafer 314. Using thermal control, the wafer 314 is maintained at a temperature of between 0 and 500 degrees Celsius.

Those skilled in the art will understand that other forms of etch chambers may be used to practice the invention, including chambers with remote plasma sources, microwave plasma chambers, electron cyclotron resonance (ECR) plasma chambers, and the like.

To facilitate control of the chamber as described above, the controller 340 may be one of any form of general purpose computer processor that can be used in an industrial setting for controlling various chambers and sub-processors. The memory, or computer-readable medium, 342 of the CPU 344 may be one or more of readily available memory such as random access memory (RAM), read only memory (ROM), floppy disk, hard disk, or any other form of digital storage, local or remote. The support circuits 346 are coupled to the CPU 344 for supporting the processor in a conventional manner. These circuits include cache, power supplies, clock circuits, input/output circuitry and subsystems, and the like. The inventive method is generally stored in the memory 342 as software routine. The software routine may also be stored and/or executed by a second CPU (not shown) that is remotely located from the hardware being controlled by the CPU 344.

The invention can be practiced in other etch semiconductor processing systems where the processing parameters may be adjusted to achieve acceptable characteristics by those skilled in the art by utilizing the teachings disclosed herein without departing from the spirit of the invention. In particular, the method is described as being implemented in the DPS™ etch chamber manufactured by Applied Materials. It is important to note that the method can be performed in other high density plasma etch chambers such as IPS®, eMAX™, and ENABLER™, all of which are available from Applied Materials. Other high density plasma etch reactors that are used to etch oxide materials would also benefit by the use of the inventive method.

Although the foregoing discussion referred to fabricating of the gate structure of a field effect transistor, fabricating of the other structures and features used in the semiconductor integrated circuits and devices can benefit from the invention.

1. A method of plasma etching a layer of oxide within a chamber comprising:
supplying a gas mixture containing a fluorocarbon gas and a fluorohydrocarbon gas to the chamber;
igniting a high-density plasma within the chamber by coupling RF energy to the gas mixture; and
etching said oxide.

2. The method of claim 1 wherein the fluorocarbon gas within said plasma source gas is selected from a group of gases containing CF₄, C₄F₆, and C₄F₈.

3. The method of claim 1 wherein the fluorohydrocarbon gas within said plasma source gas is selected from a group of gases containing CHF₃, CH₂F₂ and CH₃F.

4. The method of claim 1 wherein the gas mixture comprises 30 to 100 sccm of CF₄, and 6 to 200 sccm of CH₂F₂.

5. The method of claim 1 wherein said igniting step comprises the step of applying a bias power to a cathode electrode of 200 to 500 watts.

6. The method of claim 1 wherein said igniting step comprises the step of applying an inductive source power to an antenna of 400 to 1500 watts.

7. The method of claim 1 wherein a chamber pressure is between 4 to 60 mTorr.

8. The method of claim 1 wherein, during the etching step, a pedestal that supports the layer of oxide within the chamber is maintained at a temperature between 0 and 100 degrees Celsius.

9. The method of claim 1 wherein said oxide layer is covered in part by a photoresist layer and the etching step provides a selectivity of oxide to photoresist that is greater than 300:1.

10. The method of claim 1 wherein said high-density plasma has a plasma density greater than 10¹¹ cm³.

11. The method of claim 1 wherein the gas mixture comprises CF₄ and CH₂F₂ in a CF₄:CH₂F₂ ratio of 1:1.5.

12. The method of claim 1 wherein the gas mixture comprises CF₄ and CH₂F₂ and adjusting the ratio of CF₄:CH₂F₂ controls a selectivity of oxide over photoresist.

13. A method of plasma etching a layer of oxide comprising:
supplying a gas mixture containing CF₄ and CH₂F₂ to a chamber;
igniting a plasma within the chamber by applying a bias power to a cathode electrode of about 500 watts and by applying an inductive source power to an inductively coupled antenna of about 700 watts; and
etching said oxide.

14. The method of claim 13 wherein a gas pressure within the chamber is between 4 to 60 mTorr.

15. The method of claim 13 wherein, during the etching step, a pedestal that supports the layer of oxide within the chamber is maintained at a temperature between 0 and 100 degrees Celsius.

16. The method of claim 13 wherein said high-density plasma has a plasma density greater than 10¹¹ cm³.

17. The method of claim 13 wherein the gas mixture comprises CF₄ and CH₂F₂ in a CF₄:CH₂F₂ ratio of 1:1.5.

18. The method of claim 13 wherein the gas mixture comprises CF₄ and CH₂F₂ and adjusting the ratio of CF₄:CH₂F₂ controls a selectivity of oxide over photoresist.

19. The method of claim 13 wherein the gas mixture further comprises HeO₂.
